(19) United States
(12) Patent Application Publication
(10) Pub. No.: US 2026/0175329 A1
(43) Pub. Date: Jun. 25, 2026

(54) LASER PROCESSING DEVICE

(71) Applicant: MAKEX GLOBAL GROUP PTE. LTD., Singapore (SG)

(72) Inventor: Guangliang HOU, Singapore (SG)

(73) Assignee: MAKEX GLOBAL GROUP PTE. LTD., Singapore (SG)

(21) Appl. No.: 19/432,141

(22) Filed: Dec. 24, 2025

Related U.S. Application Data
(63) Continuation of application No. PCT/IB2024/000746, filed on Dec. 24, 2024.

(51) Int. Cl. B23K 26/70; B23K 37/02

(52) U.S. Cl. CPC B23K 26/706; B23K 37/0211

(57) ABSTRACT

The present disclosure discloses a laser processing device, which includes a casing and a flexible light-blocking structure. An inner cavity is formed within the casing. The outer side wall of the casing is provided with a material passage communicating with the inner cavity for materials to enter and exit the inner cavity. The flexible light-blocking structure is positioned within the material passage to block the material passage, preventing light within the inner cavity from transmitting outward. The flexible light-blocking structure is further configured to deform when materials enter or exit the material passage, creating a gap between the flexible light-blocking structure and the material passage for the materials to pass through.

### CROSS-REFERENCE OF RELATED APPLICATIONS

The present application claims the benefit of priority to International Patent Application No. PCT/IB2024/000746, filed on Dec. 24, 2024, which is hereby incorporated by reference in its entirety.

### TECHNICAL FIELD

The present disclosure relates to the technical field of laser processing, and particularly to a laser processing device.

### BACKGROUND

In the related art, an inner cavity is formed inside the casing of a laser processing device, and the outer wall of the casing is further provided with a material passage communicating with the inner cavity. Materials to be processed can enter the inner cavity through the material passage, so as to be processed by the laser generated by the laser head in the inner cavity. During the laser processing, there is a risk that the laser in the inner cavity may leak through the material passage, which poses a safety hazard.

### SUMMARY

The main purpose of the present disclosure is to provide a laser processing device, aiming to reduce the risk of laser leakage to the outside in the laser processing device and improve safety.

To achieve the above purpose, the present disclosure provides a laser processing device, including:
a casing, where an inner cavity is formed within the casing, and an outer side wall of the casing is provided with a material passage communicating with the inner cavity for materials to enter and exit the inner cavity; and
a flexible light-blocking structure, where the flexible light-blocking structure is positioned within the material passage to block the material passage, preventing light within the inner cavity from transmitting outward.

The flexible light-blocking structure is further configured to deform when materials enter or exit the material passage, creating a gap between the flexible light-blocking structure and the material passage for the materials to pass through.

In the technical solution of the present disclosure, an inner cavity is formed within the casing, and the outer side wall of the casing is provided with at least two material inlets communicating with the inner cavity, and the at least two material inlets are positioned on opposite sides of the casing. With this arrangement, materials to be processed can enter the inner cavity through one of the material inlets of the casing and exit the inner cavity through the other material inlet, so as to respectively realize the continuous feeding and discharging functions of the laser processing device. In one implementation, the laser processing device further includes at least two covers, which are movably positioned on the material inlets to place and support materials to be moved into and out of the inner cavity when in the open state, thereby facilitating the continuous processing of long-format materials by the laser processing device.

### BRIEF DESCRIPTION OF DRAWINGS

In order to more clearly illustrate the technical solutions in the implementations of the present disclosure or the related art, the drawings used for the description of the implementations or the related art are briefly introduced below. It is obvious that the drawings described below are only some implementations of the present disclosure, and those of ordinary skill in the art can obtain other drawings based on these drawings without creative work.

FIG. 1 is a structural schematic diagram of a laser processing device, according to some implementations of the present disclosure.

FIG. 2 is a sectional schematic diagram of the laser processing device in FIG. 1.

FIG. 3 is an enlarged view of area A in FIG. 2.

FIG. 4 is a partial sectional view of the laser processing device in FIG. 1.

FIG. 5 is a sectional schematic diagram of the laser processing device in FIG. 1 from another perspective.

FIG. 6 is a structural schematic diagram of a flexible light-blocking structure in one implementation of the laser processing device in FIG. 1.

FIG. 7 is an exploded view of the flexible light-blocking structure of the laser processing device in FIG. 6.

FIG. 8 is a sectional schematic diagram of the flexible light-blocking structure of the laser processing device in FIG. 6.

FIG. 9 is a partial structural schematic diagram of the flexible light-blocking structure of the laser processing device in FIG. 1.

FIG. 10 is a partial structural schematic diagram of another implementation of the flexible light-blocking structure of the laser processing device in FIG. 1.

FIG. 11 is a structural schematic diagram of a laser processing device, according to some implementations of the present disclosure.

FIG. 12 is a sectional structural schematic diagram of the laser processing device in FIG. 11.

FIG. 13 is a partial structural sectional view of the laser processing device in FIG. 11.

FIG. 14 is another partial structural sectional view of the laser processing device in FIG. 11.

FIG. 15 is a structural schematic diagram of the cover of the laser processing device in FIG. 11.

FIG. 16 is a structural exploded view of the cover of the laser processing device in FIG. 11.

FIG. 17 is another perspective structural exploded view of the cover of the laser processing device in FIG. 11.

FIG. 18 is a partial structural exploded view of the laser processing device in FIG. 11.

FIG. 19 is a structural schematic diagram of a laser processing device, according to some implementations of the present disclosure.

FIG. 20 is a partial structural sectional view of the laser processing device in FIG. 19.

The realization, functional features, and advantages of the present disclosure will be further described in conjunction with the implementations and with reference to the drawings.

### DETAILED DESCRIPTION

The following will provide a description of the technical solutions in the implementations of the present disclosure with reference to the drawings. Obviously, the described implementations are only a part of the implementations of the present disclosure, and not all of the implementations. Based on the implementations of the present disclosure, all other implementations obtained by those of ordinary skill in the art without creative work are within the scope of protection of the present disclosure.

It should be noted that, if there are directional indications (such as up, down, left, right, front, back, etc.) involved in the implementations of the present disclosure, such directional indications are only used to explain the relative positional relationships, movements, etc., between the components under a certain specific posture. If the specific posture changes, the directional indications may also change accordingly.

In addition, if there are descriptions such as “first,” “second,” etc., in the implementations of the present disclosure, such descriptions are only for the purpose of description and should not be understood as indicating or implying their relative importance or implicitly indicating the number of the indicated technical features. Therefore, features limited by “first,” “second,” etc., may explicitly or implicitly include at least one such feature. In addition, if “and/or” appears in the present disclosure, its meaning includes three parallel scenarios. Taking “A and/or B” as an example, it includes the scenario of A, the scenario of B, or the scenario where both A and B are satisfied. In addition, the technical solutions of various implementations can be combined with each other, but must be based on the premise that those of ordinary skill in the art can realize them. When the combination of technical solutions is contradictory or cannot be realized, it should be considered that such a combination does not exist and is not within the scope of protection required by the present disclosure.

In the related art, an inner cavity is formed inside the casing of a laser processing device, and the outer wall of the casing is further provided with a material passage communicating with the inner cavity. Materials to be processed can enter the inner cavity through the material passage, so as to be processed by the laser generated by the laser head in the inner cavity. During the laser processing, there is a risk that the laser in the inner cavity may leak through the material passage, which poses a safety hazard.

The present disclosure provides a laser processing device 100. The specific type of the laser processing device 100 can be a laser engraving machine, a laser drilling machine, etc., as long as it is a device that uses laser as a processing medium to process materials, and is not limited herein.

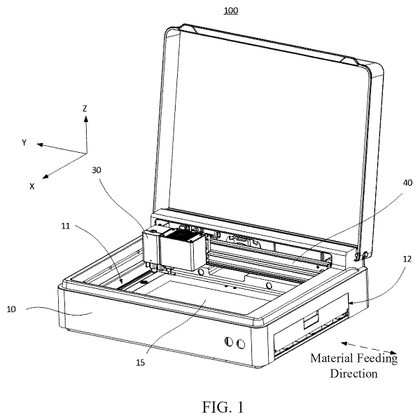

For ease of understanding and explanation, the directions indicated by the coordinate system shown in FIG. 1 are used as a reference, where the first direction is the positive direction of the x-axis, the second direction is the positive direction of the y-axis, and the third direction is the positive direction of the z-axis; the positive direction of the x-axis is the front, and the negative direction is the rear; the positive direction of the y-axis is the left, and the negative direction is the right; and the positive direction of the z-axis is upward, and the negative direction is downward.

Please refer to FIGS. 1 to 4. In one implementation of the present disclosure, the laser processing device 100 includes:
a casing 10, where an inner cavity 11 is formed within the casing 10, and an outer side wall of the casing 10 is provided with a material passage 12 communicating with the inner cavity 11 for materials to enter and exit the inner cavity 11; and
a flexible light-blocking structure 20, where the flexible light-blocking structure 20 is positioned within the material passage 12 to block the material passage 12, preventing light within the inner cavity 11 from transmitting outward.

The flexible light-blocking structure 20 is further configured to deform when materials enter or exit the material passage 12, thereby creating a gap between the flexible light-blocking structure 20 and the material passage 12 for the materials to pass through.

The casing 10 is a box structure with a hollow interior, used to form the inner cavity 11 for accommodating functional components such as the laser processing module 30, so as to achieve the function of isolating and protecting the functional components such as the laser processing module 30. By arranging the laser processing module 30 inside the casing 10, laser processing can be performed in the inner cavity 11. The casing 10 can be rectangular, square, or other shapes, and is not limited herein.

In one implementation, the outer side wall of the casing 10 is provided with a material passage 12 communicating with the inner cavity 11, which allows a user to place materials to be processed into the inner cavity 11 of the casing 10, or to take out processed materials from the inner cavity 11. The pick-and-place opening can be rectangular, square, or other shapes, and is not limited herein.

During laser processing, both ends of the material passage 12 may not be provided with a cover structure, so that the material passage 12 remains in a state of communication with both the inner cavity 11 and the outside. In this way, during laser processing, materials to be processed can be directly fed into the inner cavity 11 through the material passage 12. In addition, when the size of the material to be processed is larger than the size of the inner cavity 11, part of the material can be placed in the inner cavity 11 for processing, and the remaining part can be placed outside the casing 10 waiting for subsequent processing. At this time, the materials placed inside and outside the casing 10 can be connected through the material passage 12. In this way, the laser processing device 100 can process materials larger than the size of its inner cavity 11. On this basis, in order to prevent the laser in the inner cavity 11 from leaking to the outside through the material passage 12, which is kept in a communicating state during laser processing, the technical solution of the present disclosure provides a flexible light-blocking structure 20 in the material passage 12. Since the flexible light-blocking structure 20 is flexible, when materials pass through the material passage 12, the flexible light-blocking structure 20 can undergo flexible deformation under external force, creating a gap with the inner wall of the material passage 12, so that materials can enter and exit the inner cavity 11 through the gap. Furthermore, during laser processing, the flexible light-blocking structure 20 can fill the internal space of the material passage 12 to block the laser in the inner cavity from leaking to the outside through the material passage 12, thereby improving the safety of the laser processing device 100.

It should be noted that, in the technical solution of the present disclosure, the laser processing device 100 can realize the picking and placing of materials only through the material passage 12, or the laser processing device 100 can further be provided with other pick-and-place structures in addition to the material passage 12. For example, the casing 10 can include a chassis and a machine cover, the chassis forms an accommodating space with a top opening, and the machine cover can open and close to cover the opening of the chassis, enclosing the chassis to form the inner cavity 11. In this way, after opening the machine cover, materials can be picked and placed into the inner cavity 11 through the opening of the chassis. The specific implementation can be set according to actual needs and is not limited herein.

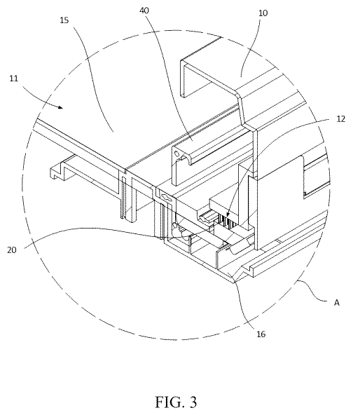

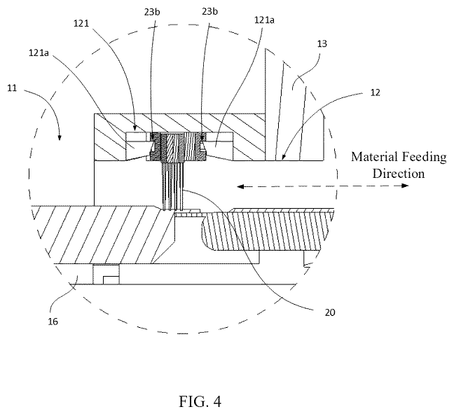

Please refer to FIGS. 3 to 4. In the implementation of the present disclosure, the flexible light-blocking structure 20 includes several flexible components 21. The flexible components 21 extend along the height direction of the material passage 12, and at least a portion of the several flexible components 21 are sequentially arranged along the width direction of the material passage 12.

All of the flexible components 21 are flexible, and are configured to deform under external force, so that the flexible light-blocking structure 20 has an initial state and a deformed state under external force. For example, when materials enter the material passage 12, the flexible components 21 can be deformed by being pushed by the materials, creating a gap with the inner wall of the material passage 12 for the materials to pass through. Furthermore, the flexible components 21 extend along the height direction of the material passage 12, so that after the materials pass through, the flexible components 21 can return to the initial state under the influence of gravity. The flexible components 21 can also be elastic, so that they can undergo elastic deformation under external force, and after elastic deformation, tend to restore themselves to the initial state.

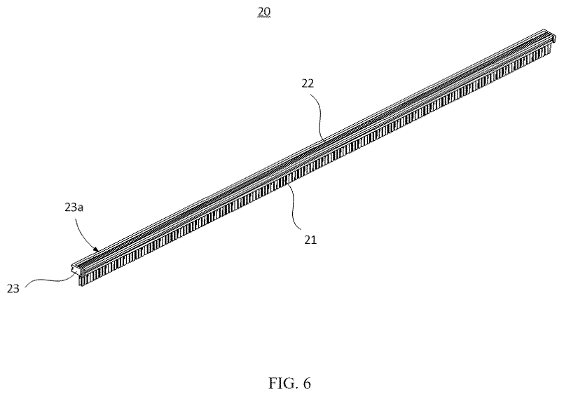

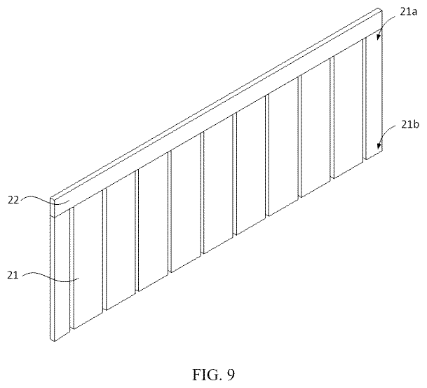

Please refer to FIGS. 6 to 9. In one implementation of the present disclosure, the flexible component 21 includes a fixed end 21a and a free end 21b set opposite each other. The fixed end 21a is positioned on one of the top or bottom walls of the material passage 12, and the free end 21b abuts the other of the top or bottom walls of the material passage 12.

Specifically, the free end 21b of the flexible light-blocking structure 20 can swing relative to the fixed end 21a under external force. In the initial state, the free end 21b of the flexible component 21 abuts the inner wall of the material passage 12. The free end 21b can also swing toward the fixed end 21a when pushed by materials, creating a gap between the free end 21b and the inner wall of the material passage 12 to allow materials entering the material passage 12 to pass through. In one implementation, when the flexible component 21 in the deformed state is not subjected to external force, the free end 21b can return to and re-abut the inner wall of the material passage 12, so that the flexible light-blocking structure 20 re-covers the material passage 12.

In this implementation, when the flexible component 21 is in the initial state, its fixed end 21a and free end 21b respectively contact the top wall and bottom wall of the material passage 12. When multiple flexible components 21 in the initial state are sequentially arranged along the width direction of the material passage 12, they can jointly fill the internal space of the material passage 12 and cooperatively cover the material passage 12 to block the laser in the inner cavity 11 from leaking to the outside through the material passage 12.

When materials pass through the material passage 12, the flexible components 21 of the flexible light-blocking structure 20 can undergo flexible deformation under external force, moving from the initial state to the deformed state. In the deformed state, there is a gap between the free end 21b of the flexible component 21 and the inner wall of the material passage 12, allowing materials to enter and exit the inner cavity 11 through the gap.

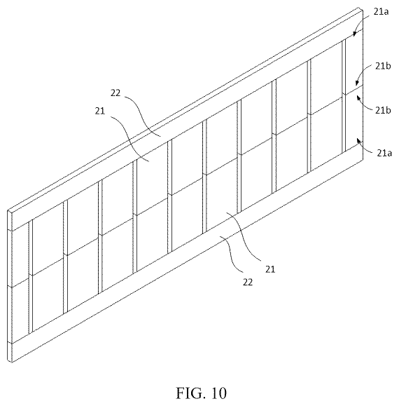

Of course, the technical solution of the present disclosure is not limited to this. Please refer to FIG. 10. In another implementation of the present disclosure, the flexible component 21 includes a fixed end 21a and a free end 21b set opposite each other. Several flexible components 21 are paired, with the fixed ends 21a of each pair positioned on the top and bottom walls of the material passage 12, and the free ends 21b of each pair abutting each other.

In this implementation, when the flexible component 21 is in the initial state, the two fixed ends 21a of each pair of flexible components 21 respectively contact the top wall and bottom wall of the material passage 12, and the two free ends 21b of each pair of flexible components 21 abut each other. When multiple pairs of flexible components 21 in the initial state are sequentially arranged along the width direction of the material passage 12, they can jointly fill the internal space of the material passage 12 and cooperatively cover the material passage 12 to block the laser in the inner cavity 11 from leaking to the outside through the material passage 12.

When materials pass through the material passage 12, the flexible components 21 of the flexible light-blocking structure 20 can undergo flexible deformation under external force. At this time, each pair of flexible components 21 can move from the initial state to the deformed state, and the two free ends 21b can be set apart from each other. Therefore, in the deformed state, there is a gap between the two free ends 21b of the two flexible components 21, so that materials can enter and exit the inner cavity 11 through the gap between each pair of flexible components 21.

Please refer to FIGS. 6 to 10. In the implementation of the present disclosure, the flexible light-blocking structure 20 further includes a fixing component 22, the fixing component 22 is positioned on the inner wall of the material passage 12 and extends along the width direction of the material passage 12, and is fixedly connected to the fixed end 21a of the flexible component 21. With this arrangement, the fixing component 22 can connect several flexible components 21 of the flexible light-blocking structure 20 to form an integrated structure, so that the flexible light-blocking structure 20 can be assembled as an integral structural component in the material passage 12, thereby improving the assembly convenience of the flexible light-blocking structure 20.

Please refer to FIG. 4. In the implementation of the present disclosure, the inner wall of the material passage 12 is provided with a groove 121, and the fixing component 22 is limited within the groove 121. With this arrangement, on the one hand, the groove can position the fixing component 22, so that the flexible light-blocking structure 20 can be quickly assembled into the material passage 12. On the other hand, the groove can limit the fixing component 22, reducing the risk of the fixing component 22 shifting under external force, thereby improving the assembly stability of the flexible light-blocking structure 20.

The shape of the groove 121 can be adapted to the fixing component 22, so that the fixing component 22 can be directly inserted into the groove 121 and limitedly fitted with the groove wall of the groove 121. In some implementations, the fixing component 22 can also be assembled into the groove 121 through other assembly structures, so as to be limitedly fitted with the groove wall of the groove 121 through the assembly structure.

In the implementation of the present disclosure, the flexible light-blocking structure 20 further includes an installation frame 23. The installation frame 23 is limited within the groove 121, and the installation frame 23 forms a frame opening 23a. At least two fixing components 22 are provided, and the at least two fixing components 22 are positioned within the frame opening 23a and arranged side by side along the extension direction of the material passage 12.

With this arrangement, the installation frame 23 can serve as the assembly structure for the fixing component 22, realizing the limited fit between the fixing component 22 and the groove. Furthermore, when the flexible light-blocking structure 20 is provided with multiple fixing components 22, multiple fixing components 22 can be integrally installed at the frame opening 23a of the installation frame 23, so that the components of the flexible light-blocking structure 20 are assembled to form an integral structure, which is convenient for the overall installation of the flexible light-blocking structure 20 and is conducive to improving the assembly convenience of the flexible light-blocking structure 20.

Please refer to FIGS. 6 to 8. In the implementation of the present disclosure, the installation frame 23 includes a side frame portion 231 and an edge frame portion 232, the side frame portion 231 includes a main segment 231a and two connecting segments 231b, the main segment 231a extends along the width direction of the material passage 12, and the two connecting segments 231b are respectively bent and connected to the opposite ends of the main segment 231a. The edge frame portion 232 extends along the width direction of the material passage 12 and is detachably connected to the two connecting segments 231b to enclose the side frame portion 231 to form the frame opening 23a.

By splitting the installation frame 23 into the side frame portion 231 and the edge frame portion 232, on the one hand, the side frame portion 231 and the edge frame portion 232 can be processed separately to reduce the processing difficulty of the installation frame 23, and on the other hand, it is convenient to assemble the fixing component 22 into the installation frame 23. Specifically, when it is necessary to install the fixing component 22, at least one end of the edge frame portion 232 can be detached from the connecting segment 231b, so that the fixing component 22 can be placed into the frame opening 23a, and then the end of the edge frame portion 232 is reassembled to the connecting segment 231b, so that the fixing component 22 in the frame opening 23a is clamped by the side frame portion 231 and the edge frame portion 232.

The connecting segment 231b can be provided with one of a slot and a block toward the edge frame portion 232, and the end of the edge frame portion 232 can be provided with the other of a slot and a block. In this way, the detachable connection between the side frame portion 231 and the edge frame portion 232 can be realized by the engagement of the slot and the block. Of course, the side frame portion 231 and the edge frame portion 232 can also be detachably connected by other connection methods such as magnetic attraction connection, threaded connection, etc., and are not limited herein.

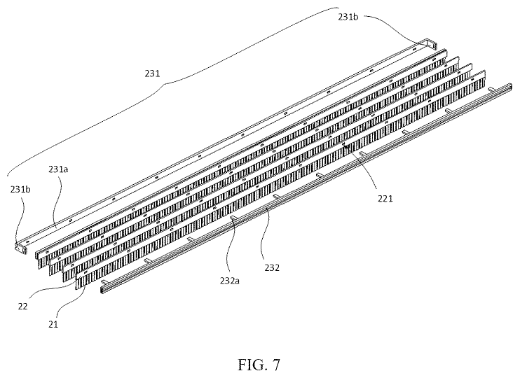

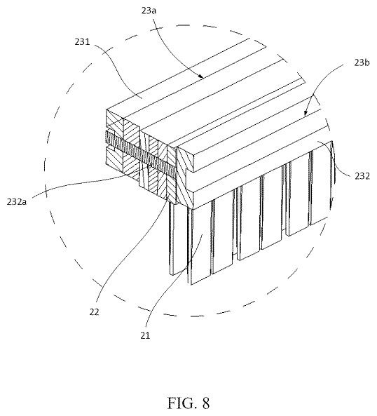

Please refer to FIGS. 7 and 8. In the implementation of the present disclosure, a connecting block 232a is provided on a side of the edge frame portion 232 facing the main segment 231a, the fixing component 22 is provided with a connecting hole 221 for the connecting block 232a to pass through, and the connecting block 232a is detachably connected to the main segment 231a.

With this arrangement, when the fixing component 22 is located in the frame opening 23a of the installation frame 23, one end of the connecting block 232a is fixedly connected to the edge frame portion 232, and the other end passes through the connecting hole 221 on the fixing component 22 to connect to the main segment 231a of the side frame portion 231. In this way, the connecting block 232a can further support and limit the fixing component 22, thereby ensuring the installation stability of the fixing component 22.

The main segment 231a of the side frame portion 231 can be provided with a slot for plug-in fit with the connecting block 232a, so as to realize the detachable connection with the connecting block 232a. Of course, the connecting block 232a and the edge frame portion 232 can also be detachably connected by other connection methods such as magnetic attraction connection, snap-fit connection, etc., and are not limited herein.

In some implementations, there are multiple connecting blocks 232a, and correspondingly, there are multiple connecting holes 221 on the fixing component 22, and each connecting block 232a is set opposite to a connecting hole 221 on the fixing component 22. When there are multiple connecting blocks 232a, the multiple connecting blocks 232a can be sequentially spaced along the width direction of the material passage 12, or can be arranged in other ways. The present disclosure does not limit the number and installation position of the connecting blocks 232a.

Please refer to FIGS. 4 and 8. In the implementation of the present disclosure, a block 121a is provided on the groove wall of the groove 121, a card interface 23b is provided on the outer wall of the installation frame 23, and the card interface 23b and the block 121a are set opposite each other to engage with the block 121a.

In some implementations, multiple blocks 121a can be provided on one side groove wall of the installation frame 23, and the multiple blocks 121a are sequentially spaced along the width direction of the material passage 12. The outer wall of the installation frame 23 can be provided with only one card interface 23b, and the card interface 23b can extend along the width direction of the material passage 12, so that multiple blocks 121a can be engaged at the same card interface 23b. Of course, the outer wall of the installation frame 23 can be provided with multiple card interfaces 23b, and each card interface 23b is set corresponding to a block 121a. The present disclosure does not limit the number and installation position of the connecting blocks 232a.

The groove walls on both sides of the groove 121 can be provided with blocks 121a, and correspondingly, the two opposite side walls of the installation frame 23 are provided with card interfaces 23b, so that both opposite sides of the installation frame 23 can be engaged with the groove 121, thereby ensuring the installation stability of the installation frame 23. The blocks 121a on the groove walls on both sides of the groove 121 can be set opposite to each other, or can be staggered in the width direction of the material passage 12. Of course, the block 121a can be provided only on one side groove wall of the groove 121, and correspondingly, the card interface 23b is provided only on one side outer wall of the installation frame 23, and is not limited herein.

Please refer to FIG. 4. In the implementation of the present disclosure, at least two flexible light-blocking structures 20 are provided, and the at least two flexible light-blocking structures 20 are sequentially and intermittently arranged along the extension direction of the material passage 12.

In one implementation, several flexible components 21 of the flexible light-blocking structure 20 are closely arranged along the width direction of the material passage 12, and a single flexible light-blocking structure 20 can achieve the covering effect on the material passage 12 to prevent the laser from leaking to the outside through the material passage 12. On this basis, by providing at least two flexible light-blocking structures 20, and arranging the at least two flexible light-blocking structures 20 sequentially and intermittently along the extension direction of the material passage 12, a multi-layer covering effect on the material passage 12 can be achieved by using at least two flexible light-blocking structures 20.

Of course, the technical solution of the present disclosure is not limited to this. In one implementation of the present disclosure, several flexible components 21 of the flexible light-blocking structure 20 can also be sequentially and intermittently arranged along the width direction of the material passage 12.

In one implementation, at least two flexible light-blocking structures 20 are staggered along the width direction of the material passage 12. In this way, the flexible components 21 of one flexible light-blocking structure 20 are projected between two adjacent flexible components 21 of another flexible light-blocking structure 20, so that at least two flexible light-blocking structures 20 can cooperatively cover the material passage 12.

In the implementation of the present disclosure, the flexible component 21 is configured as a brush.

In some implementations, the brush extends along the height direction of the material passage 12. The length of the brush can be equal to the height of the material passage 12, so that the bristles completely cover the material passage 12; or the length of the brush can be slightly longer than the height of the material passage 12 to ensure that the free end 21b of the brush can fully contact the inner wall of the material passage 12, thereby ensuring the light-blocking effect of the flexible light-blocking structure 20 on the laser.

In the implementation of the present disclosure, the flexible light-blocking structure 20 is positioned at one end of the material passage 12 near the inner cavity 11. With this arrangement, the flexible light-blocking structure 20 can be placed at the inner end of the material passage 12, which, on the one hand, conceals the flexible light-blocking structure 20 to a certain extent, and on the other hand, reduce the risk of the flexible light-blocking structure 20 being affected by the external environment, thereby improving the protection performance of the flexible light-blocking structure 20.

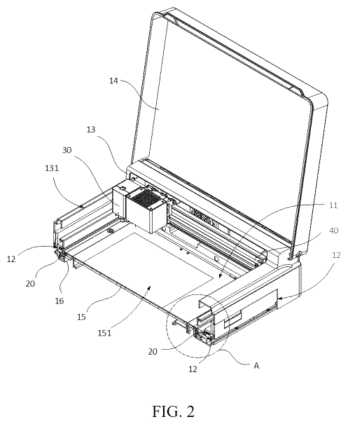

Please refer to FIG. 2. In the implementation of the present disclosure, the casing 10 is provided with two material passages 12. The two material passages 12 are positioned on opposite sides of the casing 10, and each material passage 12 is provided with at least one flexible light-blocking structure 20.

With this arrangement, materials can be placed into the inner cavity 11 for laser processing through either material passage 12, and can be taken out from the inner cavity 11 through either material passage 12. When the material to be processed is a long-format material, the part to be processed can be fed into the inner cavity 11 from the outside through one material passage 12, and the processed part can be moved out from the inner cavity 11 to the outside through the other material passage 12 of the casing 10. In this way, each part of the long-format material can be sequentially moved into the inner cavity 11, allowing the laser processing device 100 to continuously process the material.

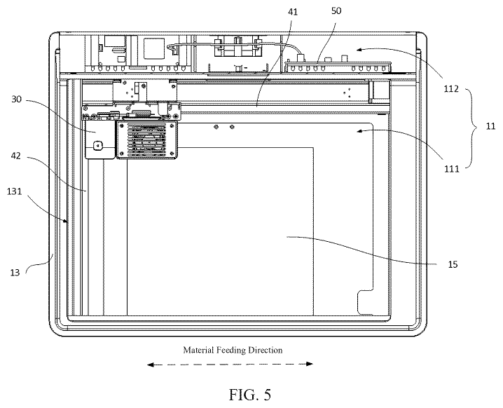

Please refer to FIG. 5. In the implementation of the present disclosure, the inner cavity 11 includes an installation chamber 112 and a processing chamber 111 sequentially communicated along the first direction; and the two material passages 12 are respectively positioned on opposite sides of the processing chamber 111 in the second direction.

With this arrangement, the control module and other functional components of the laser processing device 100 can be integrated in the installation chamber 112 of the inner cavity 11, and sufficient space can be reserved for the processing chamber 111 for placing materials and performing laser processing on the materials. At this time, by arranging the material passages 12 on opposite sides of the processing chamber 111 in the second direction, that is, the two material passages 12 are respectively located on the left and right sides of the processing chamber 111. It is convenient to directly feed and discharge materials to and from the processing chamber 111, and the installation space on the left and right sides of the casing 10 can be fully utilized, thereby achieving a compact layout of the laser processing device 100.

Of course, the technical solution of the present disclosure is not limited to this. In other implementations, the inner cavity 11 can include an installation chamber 112 and a processing chamber 111 that are sequentially communicated in the second direction, and the installation chamber 112 and the processing chamber 111 can be arranged from left to right or from right to left, and are not limited herein. Correspondingly, the material passages 12 can also be respectively arranged on opposite sides of the processing chamber 111 in the first direction, that is, the two material passages 12 are respectively located on the front and rear sides of the processing chamber 111. In some implementations, the height of the casing 10 can be increased, and the inner cavity 11 can include an installation chamber 112 and a processing chamber 111 that are communicated in the third direction, and the installation chamber 112 and the processing chamber 111 can be arranged from top to bottom or from bottom to top, and are not limited herein. The two material passages 12 can be respectively arranged on opposite sides of the processing chamber 111 in the first direction, or can be respectively arranged on opposite sides of the processing chamber 111 in the second direction. The present disclosure does not limit the arrangement positions of the two material passages 12.

Please refer to FIGS. 1 to 5. In the implementation of the present disclosure, the laser processing device 100 further includes a track device 40, a laser processing module 30, and a control module 50, the track device 40 is positioned within the processing chamber 111; the laser processing module 30 is movably positioned on the track device 40; and the control module 50 is positioned within the installation chamber 112.

A partition can be provided in the inner cavity 11 to divide the inner cavity 11 into the processing chamber 111 and the installation chamber 112. The control module 50 is positioned within the installation chamber 112, and can include, but is not limited to, a main control board, a power module, and other components. The track device 40 is positioned within the processing chamber 111, and can be directly positioned on the chamber wall of the processing chamber 111, or a frame can be provided in the processing chamber 111 to install and fix the track device 40 through the frame. The laser processing module 30 is movably positioned on the track device 40 for laser processing of materials placed in the processing chamber 111.

Specifically, the track device 40 can drive the laser processing module 30 to move through a linear drive mechanism, which can include, but is not limited to, a synchronous belt drive mechanism. The track device 40 can drive the laser processing module 30 to slide in the horizontal direction, or can drive the laser processing module 30 to slide in the vertical direction, and is not limited herein.

In one implementation, the processing chamber 111 can also be integrally provided with a lighting module for providing illumination, a detection module for sensing flames, and other functional modules. The installation chamber 112 can also be integrally provided with a fan module for driving airflow circulation and other functional modules. With this arrangement, the internal space of the casing 10 can be effectively utilized, and the utilization rate of the inner cavity 11 of the casing 10 can be improved.

Please refer to FIG. 5. In the implementation of the present disclosure, the track device 40 includes a first track assembly 41 and a second track assembly 42. The first track assembly 41 is positioned on opposite sides of the processing chamber 111 in the second direction and is set above the material passage 12; and the second track assembly 42 is movably positioned on the first track assembly 41 along the first direction, and the laser processing module 30 is movably positioned on the second track assembly 42.

Specifically, in this implementation, the second track assembly 42 can be movably positioned on the first track assembly 41 along the front-rear direction, and the laser processing module 30 can be movably positioned on the second track assembly 42, so that the track device 40 drives the laser processing module 30 to move within the processing chamber 111. By arranging the first track assembly 41 above the material passage 12, it can be set to avoid the material path of the material passage 12, thereby preventing interference between the materials entering and exiting the casing 10 through the material passage 12 and the track device 40 during laser processing.

Please refer to FIGS. 1 to 5. In the implementation of the present disclosure, the casing 10 includes a chassis 16, a shell 13, and a cover plate 14, the chassis 16 has an accommodating space; the shell 13 is positioned on the chassis 16 to enclose with the chassis 16 to form the inner cavity 11, the shell 13 is provided with a pick-and-place opening 131 communicating with the inner cavity 11, and the opposite sides of the shell 13 are respectively provided with the material passages 12; and the cover plate 14 can open and close the pick-and-place opening 131.

Since the casing 10 is assembled from the chassis 16, the bearing assembly 15, and the cover plate 14, the casing 10 can be split into simple components for separate processing, thereby improving the convenience of processing and forming the casing 10. Specifically, the chassis 16 can be integrally formed to ensure the structural strength of the casing 10. The chassis 16 has an accommodating space, the shell 13 is positioned on the chassis 16, and can cover the functional components such as the laser processing module 30 positioned on the chassis 16, so as to protect the functional modules such as the laser processing module in the inner cavity 11 of the casing 10.

In one implementation, the shell 13 is provided with a pick-and-place opening 131, which can be rectangular or square, and the present disclosure does not limit the shape of the pick-and-place opening 131. Specifically, in this implementation, the pick-and-place opening 131 is located in the processing chamber 111, so that materials can be placed into the processing chamber 111 of the casing 10 through the pick-and-place opening 131 for processing by the laser processing module 30, or processed materials can be taken out from the processing chamber 111 through the pick-and-place opening 131.

The cover plate 14 can be openably and closably positioned at the pick-and-place opening 131, and can be connected to the shell 13. For example, in some implementations, the cover plate 14 can be rotatably connected to the shell 13, so that the pick-and-place opening 131 can be opened or closed by flipping the cover plate 14 relative to the shell 13. Of course, the cover plate 14 and the shell 13 may also not be connected, and the cover plate 14 can be directly placed on the shell 13 to cover the pick-and-place opening 131, or can be directly separated from the shell 13 to open the pick-and-place opening 131. The specific implementation can be set according to actual needs and is not limited herein.

Please refer to FIG. 2. In the implementation of the present disclosure, the casing 10 further includes a bearing assembly 15. The bearing assembly 15 is positioned on the chassis 16 and located at the accommodating space; and the bearing assembly 15 has a bearing surface 151 for bearing a workpiece, and the bearing surface 151 is set flush with the bottom wall of the material passage 12.

The bearing assembly 15 can be completely accommodated in the accommodating space of the chassis 16, or a part of the bearing assembly 15 can be positioned outside the accommodating space, and a part exposed outside the accommodating space, and is not limited herein. The chassis 16 and the bearing component can be detachably connected to facilitate the replacement of different bearing assemblies 15; and the bearing assembly 15 can be at least one of a tray, a cutting board, and a honeycomb board, and is not limited herein.

In one implementation, the edge of the bearing assembly 15 is arranged adjacent to the material passage 12. When the laser processing device 100 is feeding materials, the materials to be processed can be directly placed on the bearing surface 151 of the bearing assembly 15 after entering the inner cavity 11 through the material passage 12. On this basis, by setting the bearing surface 151 of the bearing platform and the bottom wall of the material passage 12 flush, the connection between the bearing surface 151 and the bottom wall of the material passage 12 can be facilitated, achieving a smooth transition between the two, so as to avoid a height difference between the bearing surface 151 of the bearing platform and the bottom wall of the material passage 12, which would hinder the transfer of materials.

Of course, the technical solution of the present disclosure is not limited to this. In another implementation, the edge of the bearing assembly 15 can also be spaced from the material passage 12. At this time, a guiding structure can be provided between the bearing assembly 15 and the material passage 12, so that the guiding structure can guide the materials, achieving smooth transfer of materials between the material passage 12 and the bearing assembly 15.

In the related art, laser processing devices usually include an inner cavity, and the laser processing device can realize the placement and removal of materials by opening the cover plate at the top of the inner cavity. A laser head is also provided in the inner cavity to perform laser processing on materials placed in the cavity. However, in order to ensure that the materials to be processed can be smoothly placed and removed, the size of the materials to be processed needs to be limited to be smaller than the size of the cavity, so it cannot meet the need for processing long-format materials.

The present disclosure provides a laser processing device 100. The specific type of the laser processing device 100 can be a laser engraving machine, a laser drilling machine, etc., as long as it is a device that uses laser as a processing medium to process materials, and is not limited herein.

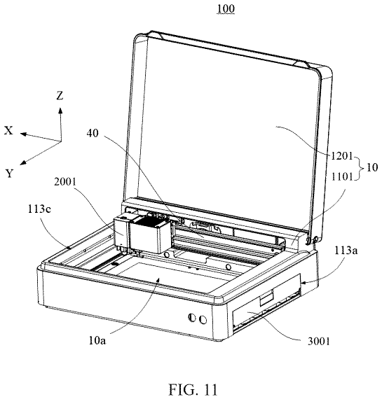

For ease of understanding and explanation, the directions indicated by the coordinate system shown in FIG. 11 are used as a reference, where the first direction is the positive direction of the x-axis, the second direction is the positive direction of the y-axis, and the third direction is the positive direction of the z-axis; the positive direction of the x-axis is left, and the negative direction is right; the positive direction of the y-axis is front, and the negative direction is rear; and the positive direction of the z-axis is up, and the negative direction is down.

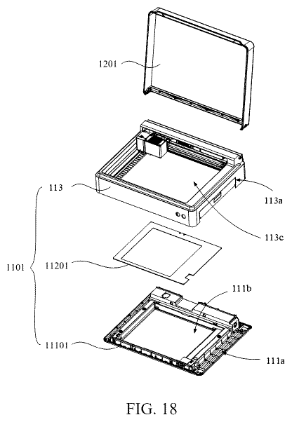

Please refer to FIGS. 11 to 20. In one implementation of the present disclosure, the laser processing device 100 includes a casing 10 and at least two covers 3001. An inner cavity 10a is formed within the casing 10, and the outer side wall of the casing 10 is provided with a material inlet 113a communicating with the inner cavity 10a. At least two material inlets 113a are provided, and the at least two material inlets 113a are positioned on opposite ends of the casing 10 for materials to enter and exit the inner cavity 10a; and the covers 3001 are movably positioned on the material inlets 113a and have an open state and a closed state.

When the covers 3001 are in the closed state, the covers 3001 close the material inlets 113a; and when the covers 3001 are in the open state, the covers 3001 open the material inlets 113a, and at least a portion of the covers 3001 is positioned near the bottom wall of the material inlets 113a to support the materials.

The casing 10 forms an inner cavity 10a to provide a space for accommodating functional components such as the laser processing module 2001 of the laser processing device 100, so as to isolate and protect the functional components accommodated in the inner cavity 10a. The casing 10 can be rectangular, square, or other shapes, and is not limited herein.

In one implementation, the outer wall of the casing 10 is provided with at least two material inlets 113a communicating with the inner cavity 10a, and the two material inlets 113a are positioned on opposite sides of the casing 10. In this way, one of the two material inlets 113a can be used for materials to be processed to enter the inner cavity 10a, and the other can be used for materials to be processed to exit the inner cavity 10a, so as to realize the feeding and discharging functions of the laser processing device 100 through the two material inlets 113a, respectively. When the size of the material to be processed is smaller than the inner cavity 10a, the material can be directly placed into the inner cavity 10a through either material inlet 113a for laser processing; when the material to be processed is a long-format material, the part to be processed can be fed into the inner cavity 10a from the outside through the material inlet 113a at one end of the casing 10, and the processed part can be moved out from the inner cavity 10a to the outside through the material inlet 113a at the other end of the casing 10. In this way, each part of the long-format material can be sequentially moved into the inner cavity 10a, so that the laser processing device 100 can continuously process long-format materials.

The laser processing device 100 further includes at least two covers 3001, each cover 3001 is movably positioned at a material inlet 113a, and has a closed state covering the material inlet 113a and an open state extending along the feeding direction of the material inlet 113a. If the size of the material to be processed is smaller than the inner cavity 10a, the covers 3001 can be kept in the closed state during laser processing to improve the sealing of the inner cavity 10a and reduce the risk of laser leakage emitted by the laser processing module 2001 in the inner cavity 10a. If the size of the material to be processed is larger than the inner cavity 10a, the covers 3001 can be kept in the open state during laser processing, so that part of the processed material is positioned outside the casing 10, and the other part is placed into the inner cavity 10a through the material inlet 113a.

It should be noted that, in some implementations, the outer side wall of the casing 10 can be provided with only two material inlets 113a, which can be positioned on opposite side walls of the casing 10, and the two material inlets 113a are set opposite to each other in the same straight line direction. Of course, in other implementations, the outer side wall of the casing can also be provided with more than two material inlets 113a. For example, the casing 10 can be provided with material inlets 113a at opposite ends in the first direction, and also at opposite ends in the second direction; or, multiple material inlets 113a can be provided on opposite side walls of the casing 10, and the multiple material inlets 113a on opposite side walls of the casing 10 are set opposite to each other in pairs. The present disclosure does not limit the specific number and orientation of the material inlets 113a.

In one implementation, when the covers 3001 are kept in the open state, at least a portion of the covers 3001 is positioned near the bottom wall of the material inlets 113a. In this way, the covers 3001 in the open state can serve as a placement and support for materials entering and exiting the inner cavity 10a, thereby facilitating the picking and placing of materials and improving the convenience of use of the laser processing device 100. Specifically, in this implementation, at least a portion of the surface of the covers 3001 is set flush with the bottom wall of the material inlets 113a, so that the two can be spliced to form the same plane, which is convenient for jointly supporting materials and allows materials to enter and exit the material inlets 113a in the horizontal direction. Of course, in other implementations, the covers 3001 can also be set at a certain angle relative to the bottom wall of the material inlets 113a to adjust the feeding and discharging angle of the materials. The present disclosure does not limit the position of the covers 3001 in the open state.

In some implementations, a light-blocking structure can be provided at the material inlet 113a to fill the internal space of the material inlet 113a. By providing a light-blocking structure, the gap size between the processed material and the inner wall of the material inlet 113a when passing through the material inlet 113a can be reduced, so that when continuously processing long-format materials, the light-blocking structure can block the laser in the inner cavity from leaking to the outside through the material inlet 113a, thereby improving the safety of the laser processing device 100.

Of course, the technical solution of the present disclosure is not limited to this. In other implementations, the material inlet 113a can be set as a slit. In this way, when continuously processing long-format materials, although the covers 3001 are in the open state and the inner cavity 10a communicates with the outside through the material inlet 113a, since the size of the material inlet 113a is small, the processed material can basically fill the material inlet 113a when passing through the material inlet 113a, so that laser leakage in the inner cavity 10a can be avoided to a certain extent. In some implementations, the size of the material inlet 113a can be set to be adjustable. By adjusting the size of the material inlet 113a, the material inlet 113a can be adapted to processed materials of different specifications, and by adapting the material inlet 113a to the processed materials, the gap size between the processed material and the inner wall of the material inlet 113a when passing through the material inlet 113a can be reduced, so as to avoid laser leakage in the inner cavity 10a to a certain extent. The specific implementation can be set according to actual needs and is not limited herein.

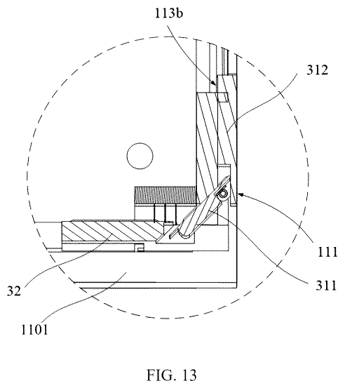

Please refer to FIGS. 13 to 17. In the implementation of the present disclosure, the cover 3001 includes a fixed portion 32 and a movable portion 31. The fixed portion 32 is positioned on one side of the material inlet 113a and fixedly connected to the casing 10. One end of the movable portion 31 is rotatably connected to the fixed portion 32, the other end is detachably connected to the casing 10. The movable portion 31 has an inner surface facing the fixed portion 32 and an outer surface away from the fixed portion 32; and the movable portion 31 is configured to swing towards the material inlet 113a to close it, or to swing away from the material inlet 113a to be positioned near the bottom wall of the material inlet 113a.

The cover 3001 includes the fixed portion 32 and the movable portion 31 that are rotatably connected in sequence. The fixed portion 32 can be fixedly positioned on the inner side of the material inlet 113a, or can be fixedly positioned on the outer side wall of the casing 10 and arranged adjacent to the material inlet 113a, so that the cover 3001 is fixedly connected to the casing 10. The movable portion 31 can be hinged to the end of the fixed portion 32 to realize the rotational connection between the movable portion 31 and the fixed portion 32.

Specifically, when the cover 3001 is in the closed state, and the movable portion 31 can cover the material inlet 113a; when the cover 3001 is in the open state, the movable portion 31 can open the material inlet 113a, and at this time, the movable portion can be positioned near the bottom wall of the material inlet 113a, so that the outer wall of the movable portion 31 can be used to place and support the processed materials entering and exiting the inner cavity 10a. The closed state and open state of the cover 3001 can be switched by flipping the movable portion 31 relative to the fixed portion 32.

In one implementation, when the cover 3001 moves from the closed state to the open state, the movable portion 31 can swing around the end of the fixed portion 32 to a position extending along the feeding direction of the material inlet 113a, so that the inner surface of the movable portion 31 is set flush with the bottom wall of the material inlet 113a. In this way, the bottom wall of the material inlet 113a and the inner surface of the movable portion 31 can be spliced to form the same plane, which is convenient for the two to jointly support materials and allows materials to enter and exit the material inlet 113a in the horizontal direction.

Please refer to FIGS. 13 to 17. In the implementation of the present disclosure, the movable portion 31 includes:
a first connecting structure 311, where one end of the first connecting structure 311 is rotatably connected to the fixed portion 32; and
a second connecting structure 312, where one end of the second connecting structure 312 is rotatably connected to an end of the first connecting structure 311 away from the fixed portion 32, and the other end can swing relative to the first connecting structure 311.

By setting the movable portion 31 as the first connecting structure 311 and the second connecting structure 312 that are rotatably connected to each other, the degree of freedom of movement of the movable portion 31 can be improved, thereby enhancing the flexibility of the arrangement of the movable portion 31. For example, when the external space of the laser processing device 100 is sufficient, both the first connecting structure 311 and the second connecting structure 312 can be arranged to extend along the feeding direction of the material inlet 113a, so that the movable portion 31 can be fully opened from the material inlet 113a and laid flat outward. At this time, the inner surfaces of the first connecting structure 311 and the second connecting structure 312 can both be set flush with the bottom wall of the material inlet 113a to cooperatively place and support the processed materials. When the external space of the laser processing device 100 is limited, only the first connecting structure 311 can be arranged to extend along the feeding direction of the material inlet 113a, and the second connecting structure 312 can be bent relative to the first connecting structure 311, thereby reducing the space required for opening the cover 3001, and the movable portion 31 can be partially opened from the material inlet 113a to allow the processed materials to pass through the material inlet 113a.

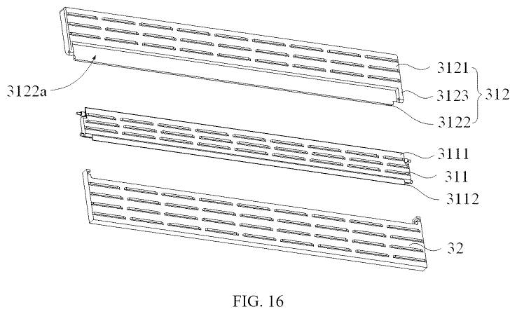

Please refer to FIG. 16. In the implementation of the present disclosure, the second connecting structure 312 includes a first main body portion 3121 and a first step portion 3122 set in a step configuration. The first step portion 3122 is positioned towards the first connecting structure 311, the first step portion 3122 has a first step surface 3122a, and the first step surface 3122a is lower than the first main body portion 3121. The second connecting structure 312 further includes two first connecting parts 3123, and the two first connecting parts 3123 are positioned on opposite sides of the first step portion 3122 and protrude from the first step surface 3122a. The first connecting structure 311 has a first extending portion 3111 at an end facing the second connecting structure 312, the first extending portion 3111 is rotatably connected between the two first connecting parts 3123, and at least a portion of the first extending portion 3111 is configured to abut the first step surface 3122a, so that the inner surface of the first connecting structure 311 is flush with the inner surface of the second connecting structure 312.

Specifically, after the cover 3001 moves from the closed state to the open state, a portion of the outer surface of the first extending portion 3111 can abut the first step surface 3122a of the first step portion 3122. At this time, the first extending portion 3111 of the first connecting structure 311 can block the first step portion 3122 of the second connecting structure 312 from further moving. With this arrangement, the maximum rotation angle of the second connecting structure 312 relative to the first connecting structure 311 can be limited. When the movable portion 31 moves to its maximum rotation angle, the first connecting structure 311 and the second connecting structure 312 of the movable portion 31 are sequentially arranged along the feeding direction of the material inlet 113a, and the inner surfaces of the first connecting structure 311 and the second connecting structure 312 can be set flush with the bottom wall of the material inlet 113a, so that the first connecting structure 311 and the second connecting structure 312 can cooperatively support the materials.

In one implementation, the two opposite sides of the first step portion 3122 are respectively provided with the first connecting parts 3123, and the first connecting parts 3123 protrude from the first step surface 3122a. In this way, a limiting space for limiting the first extending portion 3111 can be formed between the two first connecting parts 3123, which is conducive to avoiding misalignment between the first connecting structure 311 and the second connecting structure 312, thereby improving the fit stability between the first connecting structure 311 and the second connecting structure 312.

In some implementations, a rotating shaft hole can be provided in one of the first connecting part 3123 and the first extending portion 3111, and a rotating shaft is provided in the other, and the rotating shaft can be rotatably mounted in the rotating shaft hole to realize the rotational fit between the first connecting part 3123 and the first extending portion 3111. In other implementations, the first connecting part 3123 and the first extending portion 3111 can also be rotatably fitted by a hinge structure or other rotating structures, and are not limited herein.

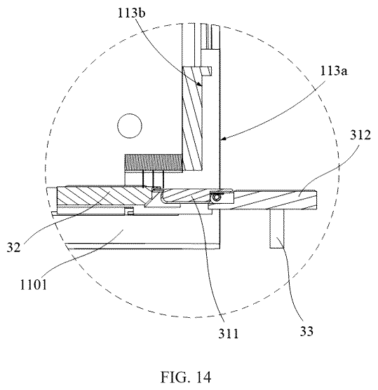

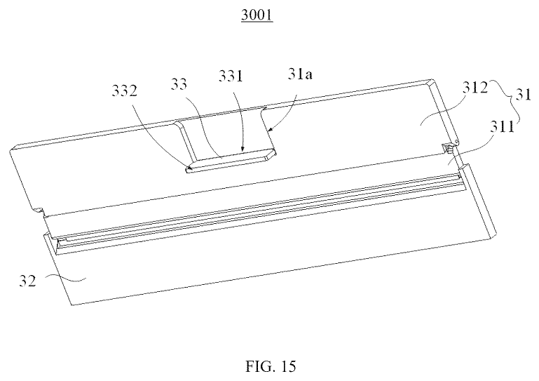

Please refer to FIGS. 14 and 15. In the implementation of the present disclosure, the fixed portion 32 is positioned on the inner wall of the material inlet 113a and is spaced from an end of the material inlet 113a away from the inner cavity 10a; and when the cover 3001 is in the closed state, the second connecting structure 312 closes an end of the material inlet 113a away from the inner cavity 10a, and the first connecting structure 311 is inclinedly connected between the fixed portion 32 and the second connecting structure 312. By arranging the first connecting structure 311 in an inclined manner when the cover 3001 is in the closed state, the vertical space occupied by the first connecting structure 311 can be saved when the cover 3001 is in the closed state.

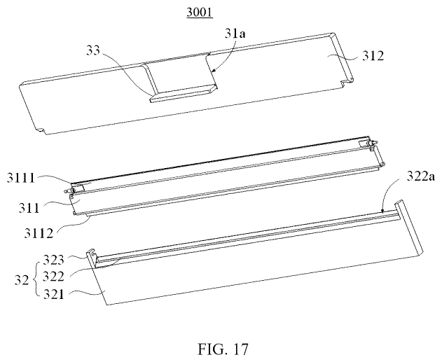

Please refer to FIG. 17. In the implementation of the present disclosure, the fixed portion 32 includes a second main body portion 321 and a second step portion 322 set in a step configuration. The second step portion 322 is positioned towards the movable portion 31. The second step portion 322 has a second step surface 322a. The fixed portion 32 further includes two second connecting parts 323. The two second connecting parts 323 are positioned on opposite sides of the second step portion 322 and protrude from the second step surface 322a. The movable portion 31 has a second extending portion 311b at an end facing the fixed portion 32. The second extending portion 311b is rotatably connected between the two second connecting parts 323, and at least a portion of the second extending portion 311b is configured to abut the second step surface 322a, so that a portion of the surface of the movable portion 31 near the fixed portion 32 is flush with the bottom wall of the material inlet 113a.

Specifically, after the cover 3001 moves from the closed state to the open state, a portion of the outer surface of the movable portion 31 can abut the second step surface 322a of the second step portion 322. At this time, the second step portion 322 of the fixed portion 32 can block the second extending portion 311b of the movable portion 31 from further moving. With this arrangement, the maximum rotation angle of the movable portion 31 relative to the fixed portion 32 can be limited. When the movable portion 31 moves to its maximum rotation angle, the movable portion 31 can be arranged to extend along the feeding direction of the material inlet 113a, and the inner surface of the movable portion 31 can be kept flush with the bottom wall of the material inlet 113a, so that the movable portion 31 can support the materials.

In one implementation, the two opposite sides of the second step portion 322 are respectively provided with the second connecting parts 323, and the second connecting parts 323 protrude from the second step surface 322a. In this way, a limiting space for limiting the second extending portion 311b can be formed between the two second connecting parts 323, thereby preventing misalignment between the fixed portion 32 and the movable portion 31, thereby improving the fit stability between the fixed portion 32 and the movable portion 31.

In some implementations, a rotating shaft hole can be provided in one of the second connecting part 323 and the second extending portion 311b, and a rotating shaft is provided in the other, and the rotating shaft can be rotatably mounted in the rotating shaft hole to realize the rotational fit between the second connecting part 323 and the second extending portion 311b. In other implementations, the second connecting part 323 and the second extending portion 311b can also be rotatably fitted by a hinge structure or other rotating structures, and are not limited herein.

Please refer to FIGS. 13 and 14. In the implementation of the present disclosure, the outer side wall of the casing 10 is further provided with a recess 113b, and the recess 113b is positioned on a side of the material inlet 113a away from the fixed portion 32 and communicates with the material inlet 113a; and when the cover 3001 is in the closed state, an end of the movable portion 31 away from the fixed portion 32 is limited within the recess 113b.

In this way, the recess 113b can be fitted with the movable portion 31 for positioning, improving the positional stability of the cover 3001 in the closed state. Furthermore, when the movable portion 31 covers the material inlet 113a, the movable portion 31 can enter the recess 113b to avoid protruding from the outer side wall of the casing 10, which is conducive to ensuring the consistency of the appearance of the laser processing device 100.

Please refer to FIGS. 13 to 17. In the implementation of the present disclosure, the cover 3001 further includes a supporting portion 33. The supporting portion 33 is movably mounted on the outer surface of the movable portion 31 to have a retracted state and an extended state. When the supporting portion 33 is in the retracted state, the supporting portion 33 is set close to the outer surface of the movable portion 31; and when the supporting portion 33 is in the extended state, at least a portion of the supporting portion 33 departs from the outer surface of the movable portion 31 and protrudes in a direction away from the movable portion 31 to support the movable portion 31.

In this implementation, there may be a certain distance between the bottom wall of the material inlet 113a and the bottom wall of the laser processing device 100. When the cover 3001 opens the material inlet 113a, the portion of the movable portion 31 extending out of the material inlet 113a will generally be in a suspended state. At this time, by providing the supporting portion 33 on the outer surface of the movable portion 31, at least a portion of the supporting portion 33 can depart from the outer surface of the movable portion 31 and contact an external structure such as the ground or a placement table when the cover 3001 opens the material inlet 113a, so that the supporting portion 33 supports the movable portion 31, thereby improving the positional stability of the movable portion 31. When the cover 3001 covers the material inlet 113a, the supporting portion 33 can be set close to the outer surface of the movable portion 31 to reduce the space occupied by the laser processing device 100.

When the supporting portion 33 is in the extended state, its extension direction can be set parallel to the normal direction of the outer surface of the movable portion 31, so that the supporting portion 33 is vertically set at the bottom of the movable portion 31; and its extension direction can also be set at other angles to reduce the space occupied by the supporting portion 33 in the vertical direction, and is not limited herein.

Please refer to FIGS. 14 and 15. In the implementation of the present disclosure, the outer surface of the movable portion 31 is provided with a mounting groove 31a. The supporting portion 33 includes a fixed end 331 and a movable end 332 set opposite each other, the fixed end 331 is positioned within the mounting groove 31a and is rotatably connected to the groove wall of the mounting groove 31a, and the movable end 332 is configured to swing around the fixed end 331. When the supporting portion 33 is in the retracted state, the movable end 332 is positioned within the mounting groove 31a, and the supporting portion 33 is housed within the mounting groove 31a; and when the supporting portion 33 is in the extended state, the movable end 332 exits the mounting groove 31a, and at least a portion of the supporting portion 33 extends out of the mounting groove 31a.

In this way, the mounting groove 31a can be fitted with the supporting portion 33 for positioning, improving the positional stability of the supporting portion 33 in the retracted state. Furthermore, when the supporting portion 33 is in the retracted state, the supporting portion 33 can be completely placed within the mounting groove 31a to avoid protruding from the outer surface of the movable portion 31, which is conducive to ensuring the consistency of the appearance of the cover 3001.

In some implementations, a handle position can be provided on one side of the supporting portion 33. By providing the handle position, the user can easily hold the supporting portion 33 to switch between the retracted state and the extended state of the supporting portion 33.

In the implementation of the present disclosure, an end of the movable portion 31 away from the fixed portion 32 is detachably connected to the casing 10. With this arrangement, when the cover 3001 is in the closed state, the movable portion 31 can be connected to the casing 10 to stably maintain the cover 3001 in the closed state. When it is necessary to open the material inlet 113a, the movable portion 31 can be detached from the casing 10 to allow it to be separated from the casing 10, so that the cover 3001 can be moved relative to the material inlet 113a to the open state.

In one implementation of the present disclosure, the cover 3001 is provided with a first magnetic component, the casing 10 is provided with a second magnetic component, and when the cover 3001 is in the closed state, the first magnetic component and the second magnetic component are magnetically connected. In another implementation of the present disclosure, the cover 3001 is provided with one of a slot and a buckle, the casing 10 is provided with the other of a slot and a buckle, and when the cover 3001 is in the closed state, the slot and the buckle are engaged.

Of course, the cover 3001 can also be detachably mounted to the casing 10 by other means such as threaded connection, and is not limited herein. In some implementations, the cover 3001 can be mounted to the casing 10 by two or more detachable connection methods at the same time, thereby further improving the positional stability of the cover 3001 in the closed state.

It should be noted that, in the implementations of the present disclosure, the two material inlets 113a are respectively positioned on opposite sides of the casing 10 in the first direction, or the two material inlets 113a are respectively positioned on opposite sides of the casing 10 in the second direction.

Specifically, in one implementation of the present disclosure, as shown in FIGS. 11 to 14, the two material inlets 113a can be respectively positioned on opposite sides of the casing 10 in the first direction, that is, the two material inlets 113a are positioned on the left and right sides of the casing 10. The material inlet 113a on the right side of the casing 10 can be used for materials to enter the inner cavity for feeding, and the material inlet 113a on the left side of the casing 10 can be used for materials to exit the inner cavity for discharging. With this arrangement, the laser processing device 100 can realize continuous processing in the first direction. Of course, the material inlet 113a on the left side of the casing 10 can be used for feeding, and the material inlet 113a on the right side of the casing 10 can be used for discharging, and is not limited herein.

At this time, the fan assembly and other functional components of the laser processing device 100 can be positioned on the front and rear sides of the inner cavity 10a, realizing a reasonable layout of the internal structure of the laser processing device 100 and leaving sufficient space for the processing area in the inner cavity 10a.

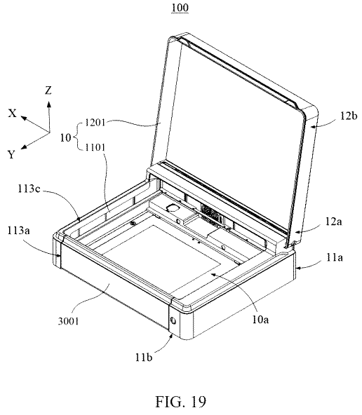

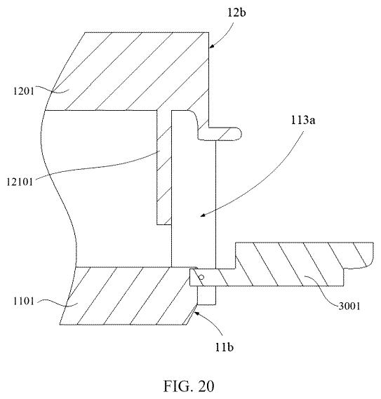

In another implementation of the present disclosure, as shown in FIGS. 19 and 20, the two material inlets 113a can also be respectively positioned on opposite sides of the casing 10 in the second direction, that is, the two material inlets 113a are positioned on the front and rear sides of the casing 10. The material inlet 113a on the rear side of the casing 10 can be used for materials to enter the inner cavity for feeding, and the material inlet 113a on the front side of the casing 10 can be used for materials to exit the inner cavity for discharging. With this arrangement, the laser processing device 100 can realize continuous processing in the second direction. Of course, the material inlet 113a on the front side of the casing 10 can be used for feeding, and the material inlet 113a on the rear side of the casing 10 can be used for discharging, and is not limited herein.

At this time, the fan assembly and other functional components of the laser processing device 100 can be positioned on the left and right sides of the inner cavity 10a, realizing a reasonable layout of the internal structure of the laser processing device 100 and leaving sufficient space for the processing area in the inner cavity 10a.

Of course, in some implementations, the laser processing device 100 can also be provided with material inlets 113a on both the left and right sides and the front and rear sides of the casing 10. In this way, the laser processing device 100 can realize continuous processing in both the first direction and the second direction. The specific implementation can be set according to actual needs and is not limited herein.

Please refer to FIGS. 11 to 20. In the implementation of the present disclosure, the casing 10 includes:
a shell main body 1101, where the shell main body 1101 forms an accommodating space with a top-side opening 113c, and the opposite sides of the shell main body 1101 are respectively provided with a material inlet 113a; and
a machine cover 1201, where the machine cover 1201 can open and close to cover the opening 113c, enclosing the shell main body 1101 to form the inner cavity 10a.

In some implementations, the size of the opening 113c on the shell main body 1101 matches the size of the processing area in the inner cavity 10a. When the size of the material to be processed is smaller than the size of the processing area, materials can be directly picked and placed into the inner cavity 10a through the opening 113c at the top of the shell main body 1101, further improving the convenience of picking and placing materials.

In some implementations, the top side of the shell main body 1101 is further provided with a limiting step, the limiting step is arranged around the opening 113c in the circumferential direction, and when the machine cover 1201 covers the opening 113c, it can be lapped on the limiting step, so that the machine cover 1201 can tightly cover the top side of the shell main body 1101.

Please refer to FIGS. 19 and 20. In the implementation of the present disclosure, the two material inlets 113a are respectively positioned on opposite sides of the shell main body 1101 in the second direction, and the shell main body 1101 includes a first side wall 11a and a second side wall 11b positioned opposite and spaced in the second direction; and the machine cover 1201 includes a first end 12a and a second end 12b positioned opposite each other, the first end 12a is rotatably connected to the first side wall 11a, and the second end 12b is detachably connected to the second side wall 11b, at least a portion of the second side wall 11b is formed by a cover 3001 positioned on one side of the shell main body 1101.

It can be understood that, by forming the second side wall of the shell main body 1101 with the cover 3001 on one side of the shell main body 1101, the consistency of the appearance of the casing 10 can be ensured. In one implementation, by making at least a portion of the second side wall of the shell main body 1101 formed by the cover 3001 on one side of the shell main body 1101, when the cover 3001 on one side of the shell main body 1101 is opened, the side of the casing 10 with the cover 3001 can be set through, providing a larger material passage space, which is convenient for picking and placing processed materials in the inner cavity 10a.

Specifically, in this implementation, the first side wall 11a can be positioned on the rear side of the casing 10, and the cover 3001 is positioned on the front side of the casing 10 to form the second side wall 11b of the casing 10. The cover 3001 can be used to form only a portion of the second side wall of the shell main body 1101, or can be used to form the entire second side wall of the shell main body 1101, and is not limited herein.

Please refer to FIG. 20. In the implementation of the present disclosure, the second end of the machine cover 1201 is provided with a blocking portion 12101. When the cover 3001 on one side of the shell main body 1101 is open, the machine cover 1201 closes the opening 113c and causes the blocking portion 12101 to extend into the material inlet 113a to prevent light within the shell main body 1101 from transmitting outward.

The blocking portion 12101 is made of an opaque material. After the cover 3001 on the front side of the casing 10 is opened, the blocking portion 12101 can extend into the material inlet 113a to cover a portion of the area of the material inlet 113a, so as to avoid a large gap between the periphery of the material and the casing 10 when materials are passing through the front side of the casing 10, which would result in a high risk of light leakage from the casing 10. The blocking portion 12101 can be integrally formed with the main structure of the machine cover 1201 to ensure the structural strength of the machine cover 1201; and the blocking portion 12101 can also be set separately from the main structure of the machine cover 1201 and detachably connected to the main structure of the machine cover 1201, so that different sizes of blocking portions 12101 can be replaced to achieve different covering effects.

In addition, when the cover 3001 on the front side of the shell main body 1101 is in the closed state, the blocking portion 12101 can also be arranged side by side with the cover 3001 in the front-rear direction, so that a double light-blocking effect for the laser can be achieved, resulting in better light-blocking performance.

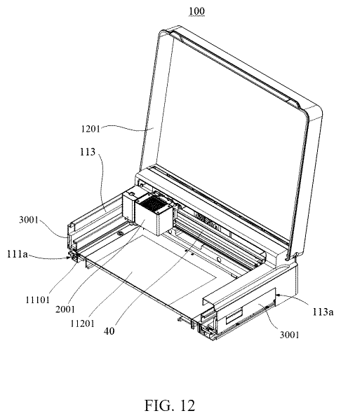

Please refer to FIGS. 11 and 12. In the implementation of the present disclosure, the laser processing device 100 further includes a track device 40 and a laser processing module 2001. The track device 40 is positioned within the inner cavity 10a, and the laser processing module 2001 is movably positioned on the track device 40.

Specifically, the track device 40 is used to drive the laser processing module 2001 to move; and the laser processing module 2001 is used to emit laser to the materials placed in the inner cavity 10a for laser processing. The track device 40 can drive the laser processing module 2001 to slide in the horizontal direction, or can drive the laser processing module 2001 to slide in the vertical direction, and is not limited herein.

Specifically, in this implementation, the track device 40 includes a first track assembly and a second track assembly, the first track assembly is installed in the inner cavity 10a and arranged along the first direction on opposite sides of the inner cavity 10a, the second track assembly is reciprocally movable along the second direction perpendicular to the first direction on the first track assembly, and the laser processing module 2001 is movably positioned on the second track assembly, so that the laser processing module 2001 can at least translate in two mutually perpendicular directions.

In addition, the track device 40 can further include a front support frame and a rear support frame, the front support frame extends along the first direction and is connected to the two first track assemblies, the front support frame is positioned on the front side of the first track assembly, the rear support frame extends along the first direction and is connected to the two first track assemblies, and the rear support frame is positioned on the rear side of the first track assembly. With this arrangement, on the one hand, the structural stability of the track device 40 can be improved, and on the other hand, functional components such as a flame sensor and a lighting lamp can be fixed by the front support frame and/or the rear support frame.

Please refer to FIGS. 11 and 12. In the implementation of the present disclosure, the shell main body 1101 further includes a chassis 11101, a bearing assembly 11201, and a shell 113, the chassis 11101 is an integrated structure and has an accommodating space 111b, the track device 40 is positioned on the chassis 11101; the bearing assembly 11201 is positioned on the chassis 11101 and located at the accommodating space 111b, and the laser processing module 2001 is configured to process a workpiece positioned on the bearing assembly 11201; and the shell 113 is positioned on the chassis 11101 and covers the track device 40 and the laser processing module 2001, the shell 113 is provided with the opening 113c, and the opposite sides of the shell 113 are respectively provided with a material inlet 113a.

Specifically, by setting the shell main body 1101 to include the chassis 11101, the bearing assembly 11201, and the shell 113, it can be split into relatively simple components for separate processing, which is conducive to improving the convenience of processing and forming the shell main body 1101. Of course, in other implementations, the shell main body 1101 can also be set as an integrated structure, so as to ensure the structural strength of the shell main body 1101.

The chassis 11101 is set as an integrated structure, which is conducive to ensuring the structural strength of the chassis 11101 and simplifying the assembly process of the shell main body 1101. There are various ways to set the chassis 11101 as an integrated structure. For example, the chassis 11101 can be integrally injection-molded, and by setting the chassis 11101 as a plastic material, it is conducive to achieving a weight reduction effect; or the chassis 11101 can be integrally die-cast, and the present disclosure does not limit the forming method of the chassis 11101.

In one implementation, the chassis 11101 forms an accommodating space 111b for accommodating the bearing assembly 11201. The bearing assembly 11201 can be positioned within the accommodating space 111b, or can be positioned outside the accommodating space 111b, or a part can be positioned within the accommodating space 111b and another part outside the accommodating space 111b, and is not limited herein. The bearing assembly 11201 can be fixedly installed on the chassis 11101, or can be detachably positioned on the chassis 11101; and the bearing assembly 11201 can be specifically configured as at least one of a tray, a cutting board, and a honeycomb board, and is not limited herein.

Please refer to FIG. 12. In the implementation of the present disclosure, the chassis 11101 is annularly set to form the accommodating space 111b, the chassis 11101 forms an annular groove 111a along its annular direction, and at least a portion of the track device 40 is positioned within the annular groove 111a.

It can be understood that, by setting the chassis 11101 in an annular shape, the structural strength of the chassis 11101 can be increased. An annular groove 111a is also formed on the chassis 11101. By positioning at least a portion of the track device 40 within the annular groove 111a, the annular groove 111a can serve as a positioning function, so that the track device 140 can be quickly and stably installed on the chassis 11101, which is conducive to improving the assembly convenience and structural stability of the laser processing device 100. In addition, the chassis 11101 can form an accommodating space in the middle for accommodating the bearing assembly 11201, and the annular groove 111a is positioned on the periphery of the accommodating space 111b. With this arrangement, the overall space utilization of the chassis 11101 can be improved.

The above is only exemplary implementations of the present disclosure and does not limit the scope of the present disclosure. Any equivalent structural transformation made using the technical concept of the present disclosure and the contents of the specification and drawings, or directly/indirectly applied to other related technical fields, are all included in the scope of patent protection of the present disclosure.

What is claimed is:

1. A laser processing device, comprising:
a casing, wherein an inner cavity is formed within the casing, and an outer side wall of the casing is provided with a material passage communicating with the inner cavity for materials to enter and exit the inner cavity; and
a flexible light-blocking structure, wherein the flexible light-blocking structure is positioned within the material passage to block the material passage, preventing light within the inner cavity from transmitting outward,
wherein the flexible light-blocking structure is further configured to deform when materials enter or exit the material passage, creating a gap between the flexible light-blocking structure and the material passage for the materials to pass through.

2. The laser processing device according to claim 1, wherein the flexible light-blocking structure comprises a plurality of flexible components, the flexible components extend along a height direction of the material passage, and at least a portion of the plurality of flexible components are sequentially arranged along a width direction of the material passage.

3. The laser processing device according to claim 2, wherein each of the plurality of flexible component comprises a fixed end and a free end set opposite each other; and
wherein the fixed end is positioned on one of top or bottom walls of the material passage, with the free end abutting the other of the top or bottom walls; or the plurality of flexible components are paired, with fixed ends of each pair positioned on the top and bottom walls of the material passage, and free ends of each pair abutting each other.

4. The laser processing device according to claim 3, wherein the flexible light-blocking structure further comprises a fixing component, and the fixing component is positioned on an inner wall of the material passage and extends along the width direction of the material passage, and is fixedly connected to the fixed end of the plurality of flexible component.

5. The laser processing device according to claim 4, wherein the inner wall of the material passage is provided with a groove, and the fixing component is limited within the groove.

6. The laser processing device according to claim 5, wherein the flexible light-blocking structure further comprises an installation frame, the installation frame is limited within the groove, and the installation frame forms a frame opening; and
wherein at least two fixing components are provided, and the at least two fixing components are positioned within the frame opening and arranged side by side along the extension direction of the material passage.

7. The laser processing device according to claim 6, wherein the installation frame comprises:
a side frame portion, wherein the side frame portion comprises a main segment and two connecting segments, the main segment extends along the width direction of the material passage, and the two connecting segments are respectively bent and connected to opposite ends of the main segment; and
an edge frame portion, wherein the edge frame portion extends along the width direction of the material passage and is detachably connected to the two connecting segments to enclose with the side frame portion to form the frame opening.

8. The laser processing device according to claim 7, wherein a connecting block is provided on a side of the edge frame portion facing the main segment, the fixing component is provided with a connecting hole for the connecting block to pass through, and the connecting block is detachably connected to the main segment.

9. The laser processing device according to claim 6, wherein a block is provided on a groove wall of the groove, a card interface is provided on the outer wall of the installation frame, and the card interface and the block are set opposite each other to engage with the block.

10. The laser processing device according to claim 2, wherein at least two flexible light-blocking structures are provided, and the at least two flexible light-blocking structures are sequentially and intermittently arranged along the extension direction of the material passage.

11. The laser processing device according to claim 10, wherein the at least two flexible light-blocking structures are staggered along the width direction of the material passage.

12. The laser processing device according to claim 2, wherein each of the plurality of flexible components is configured as a brush.

13. The laser processing device according to claim 1, wherein the flexible light-blocking structure is positioned at one end of the material passage near the inner cavity.

14. The laser processing device according to claim 1, wherein the casing is provided with two material passages, the two material passages are positioned on opposite sides of the casing, and each material passage is provided with at least one flexible light-blocking structure.

15. The laser processing device according to claim 14, wherein the inner cavity comprises an installation chamber and a processing chamber sequentially communicated along a first direction; and
wherein the two material passages are respectively positioned on opposite sides of the processing chamber in a second direction.

16. The laser processing device according to claim 15, wherein the laser processing device further comprises:
a track device, wherein the track device is positioned within the processing chamber;
a laser processing module, wherein the laser processing module is movably positioned on the track device; and
a control module, wherein the control module is positioned within the installation chamber.

17. The laser processing device according to claim 16, wherein the track device comprises:
a first track assembly, wherein the first track assembly is positioned on opposite sides of the processing chamber in the second direction and is set above the material passage; and
a second track assembly, wherein the second track assembly is movably positioned on the first track assembly along the first direction, and the laser processing module is movably positioned on the second track assembly.

18. The laser processing device according to claim 14, wherein the casing comprises:
a chassis, wherein the chassis is provided with an accommodating space;
a shell, wherein the shell is positioned on the chassis to enclose with the chassis to form the inner cavity, the shell is provided with a pick-and-place opening communicating with the inner cavity, and the opposite sides of the shell are respectively provided with the material passages; and
a cover plate, wherein the cover plate is configured to open and close the pick-and-place opening.

19. The laser processing device according to claim 18, wherein the casing further comprises a bearing assembly, and the bearing assembly is positioned on the chassis and located at the accommodating space; and
wherein the bearing assembly is provided with a bearing surface for bearing a workpiece, and the bearing surface is set flush with a bottom wall of the material passage.

20. The laser processing device according to claim 1, wherein the material passage is a material inlet, at least two material inlets are provided, and the at least two material inlets are positioned on opposite ends of the casing for materials to enter and exit the inner cavity;
wherein the laser processing device further comprises at least two covers, and the covers are movably positioned on the material inlets and have an open state and a closed state; and
wherein when the covers are in the closed state, the covers close the material inlets, and when the covers are in the open state, the covers open the material inlets, and at least a portion of the covers are positioned near a bottom wall of the material inlets to support the materials.
